(19) United States
(12) Patent Application Publication
(10) Pub. No.: US 2008/0152802 A1
(43) Pub. Date: Jun. 26, 2008

(54) Method for cleaning, method and device for the application of a protective medium to a turbine blade, and a method for placing cooling bores in a turbine blade

(75) Inventors: Erwin Bayer, Dachau (DE); Max Niegl, Muenchen (DE); Detlev Schuenke, Muenchen (DE); Michael Unger, Muenchen (DE); Karsten Loehr, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 11/699,806

(22) Filed: Jan. 30, 2007

(30) Foreign Application Priority Data
Dec. 23, 2006 (DE) 10 2006 061 444.5

(51) Int. Cl. B05D 7/22; B08B 9/00; B23K 26/38; B08B 7/00

(52) U.S. Cl. 427/230; 134/21; 219/121.71; 134/5; 134/107

(57) ABSTRACT

A method for cleaning, method and device for the application of a protective medium to a turbine blade, and a method for placing cooling bores in a turbine blade is disclosed. For this purpose, hot supercritical carbon dioxide is used as a tempering and/or cleaning medium and compressed and decompressed one or more successive times. The cleaning medium is decompressed to a pressure at which the gas assumes a volume that is a multiple of the volume of the compressed cleaning medium in the pressure tank. In so doing, it is possible to remove particulate and other impurities, even from recesses, blind holes, or open hollow spaces.

This application claims the priority of German Patent Document No. 10 2006 061 444.5, filed Dec. 23, 2006, the disclosure of which is expressly incorporated by reference herein.

### BACKGROUND AND SUMMARY OF THE INVENTION

The invention relates to a method for cleaning, a method and a device for the application of a protective medium to a turbine blade, and a method for placing cooling bores in a turbine blade to which such a protective medium has been applied.

The increase in operating temperatures of turbines into the range of the melting point of the materials, which is characteristic of modern engines, was possible only by virtue of enormous advances in cooling technology. In such cases, it was no longer possible to limit oneself to cooling the hot components by a coating of air from outside; rather, cooling from the inside must be made possible as well. The air provided for cooling the turbine originates from the so-called internal air system of an engine. This term is used to describe the streams of air that are not involved in producing the thrust. The air required for cooling the turbine is conducted into the interior of the turbine blades by way of cooling holes.

A relatively new method of boring cooling holes of this type into a hollow turbine blade is laser boring. With this method, it is essential that the laser beam penetrate only the wall of the hollow turbine blade that is intended for boring without damaging the opposite wall. In order to guarantee this, the interior hollow spaces of the turbine blade are filled with an easily vaporizable protective medium (usually wax, sometimes oil as well). On the one hand, the protective medium prevents the laser beam from also boring into the opposite wall. On the other hand, the expanding and evaporating protective medium presses the wall material that has been melted by the laser beam out of the bore. However, this does not always completely succeed and, in such cases, the remainder of the melted and re-hardened material remains in the bore or its surroundings. Subsequently, it is usually necessary for the protective medium and any hardened residue of the wall material to be laboriously removed.

Cleaning the coated blades, as well as filling them completely with the protective medium, is becoming ever more difficult as the structural complexity of the interior hollow chambers continues to grow. Therefore, hollow turbine blades are commonly preheated in an oven before being filled with a protective medium so that the protective medium remains liquid as long as possible during the filling process, so as to be able to fill even the last hollow spaces. The required even temperature for all interior structures requires relatively long processing times. Moreover, there is the danger of operating personnel being burned while removing the hot turbine blades from the oven.

Up to now, the removal of the protective medium from the turbine blade after the laser boring of the cooling holes has normally been accomplished by melting it out at high temperatures and by means of fluorocarbon baths (earlier chlorofluorocarbon baths). German Patent Document No. DE 10218519 C1 discloses cleaning components that have been contaminated by chippings or bore residues using supercritical CO₂ at a pressure greater than 500 bar and a temperature greater than 150° C.

The object of the invention is therefore to provide a method for cleaning a turbine blade that has been coated with a protective medium, a method and device for applying a protective medium to a turbine blade particularly efficiently and in as safe a manner as possible, as well as a particularly efficient method for placing cooling bores in a turbine blade.

The cleaning according to the invention of a turbine blade provided with a protective medium, in particular wax, occurs by means of supercritical CO₂ in a pressure tank, with the CO₂ being compressed and decompressed one or more consecutive times and, for this purpose, compressed to a pressure in excess of 500 bar and heated to a temperature above 150° C. and subsequently decompressed and cooled, such that the gas assumes a volume that is a multiple of the volume of the compressed CO₂ in the pressure tank.

Here, the supercritical CO₂ serves as a heat transfer medium with a high heat capacity and serves directly to melt out the wax and drive it out of filled hollow spaces. The CO₂ dissolves easily in wax, whereby it is quickly diffused into the wax and the wax is melted out more quickly. In addition, the CO₂ dissolved in the wax reduces the viscosity of the liquid wax, whereby the wax may be removed not only through large bores, but rather also through small cooling air bores.

The application according to the invention of a protective medium to a turbine blade, in particular to the inner surface of a hollow turbine blade, occurs by means of the following process steps:
insertion of the turbine blade into a pressure tank,
increasing the, pressure and temperature into the supercritical range of the CO₂,
heating the turbine blade by the introduction of hot, supercritical CO₂,
removal of the CO₂ from the pressure tank,
lowering the pressure under normal pressure,
introduction of the liquid protective medium into the hollow turbine blade,
adjustment of the environmental conditions in the pressure tank, and removal of the turbine blade.

Hot, supercritical carbon dioxide is able to move easily through gaps and therefore fills even the smallest hollow spaces of the turbine blade completely. By filling the pressure chamber and, at the same time, the hollow spaces of the turbine blade with the hot liquid, the turbine blade is tempered at the same time from the inside and the outside and thus it is tempered considerably more evenly and quickly than in a conventional heating process in an oven. Moreover, when the supercritical carbon dioxide is removed, any impurities that may be present in the hollow spaces such as, for example, dust, are rinsed out as well. Dust bores that may otherwise be necessary can now be omitted.

The reduction in the pressure under normal or ambient pressure after the heating of the turbine blade eases the insertion of the protective medium into the hollow spaces of the turbine blade. Normally, easily evaporated media are injected, such as, for example, liquid wax, which distributes itself very well in the hollow spaces at low pressure and, after normal or ambient pressure has been restored, quickly hardens. It is then possible to remove the turbine blade that has been provided with a protective medium from the pressure tank without any danger.

Moreover, it has been shown that the application of the liquid protective medium in a vacuum precludes the formation of pores, which would otherwise occur. This prevention of pores increases the process safety of a subsequent laser boring.

In addition to its very good permeation of gaps, the supercritical carbon dioxide excels as a tempering medium by virtue of the fact that it is easily obtainable, reasonably priced, and, as a normal component of air, has no environmental impact.

Supercritical carbon dioxide and the associated systems engineering are used particularly effectively when, in addition to the tempering process for the insertion of the protective medium before the laser boring, the cleaning process after laser boring is also conducted using supercritical carbon dioxide and preferably using the same system engineering.

An advantageous method of this type for placing cooling bores in a turbine blade includes these process steps:
application of a protective medium as described above,
placing the cooling bores using laser beams, and
cleaning the turbine blade using supercritical CO₂.

Here, the cleaning of the turbine blade using supercritical CO₂ is accomplished as already described above. The CO₂ cleaning medium is compressed and decompressed several consecutive times. The cleaning medium is compressed to a pressure in excess of 500 bar, preferably in excess of 600 bar, and heated to a temperature above 150° C. Subsequently, it is decompressed and cooled so that the gas assumes a volume that is a multiple of the volume of the compressed cleaning medium in the pressure tank. Using these process steps, it is possible to remove easily vaporized protective media (waxes or oils) almost completely.

The upper limit of the pressure is determined by financial and technical calculations and, as a rule, does not exceed 1000 bar.

The upper limit of the temperature is determined by the pyrolysis temperature of the wax and, as a rule, does not exceed 400° C.

According to the invention, the cleaning medium is compressed to such an extent that the gas expands to a multiple of the volume of the compressed gas and preferably expands to a volume around 100 times the volume of the compressed gas.

When the gas expands or is released, streams occur in recesses of objects to be cleaned that are directed outwards; these streams effectively carry impurities and adhering protective media along. If the compression and decompression are preformed repeatedly, with the impurities being removed from the cleaning medium each time, it is possible to clean components with complex shapes very thoroughly.

As early as DE 10218519 C1, the use of so-called removal aids has been suggested. A removal aid is a non-gaseous material in which the compressed cleaning medium is soluble and that has a tendency to bond with impurities applied to an object to be cleaned and/or placed in any open hollow spaces in the object, before the object is placed in the pressure tank. The non-gaseous medium is preferably liquid, plastic, or pasty in order to guarantee good adhesion to the impurities. By virtue of its solubility with the compressed cleaning medium, the removal aids are removed particularly well from the recesses during decompression and, in so doing, remove impurities as well. Consequently, even very small or highly inaccessible impurities can be removed. Suitable removal aids are commercially available alcohols, oils, fats, or waxes that are hydrocarbon based and in which carbon dioxide is soluble.

In the case of a turbine blade that has been provided with cooling holes and protected with wax as a protective medium, therefore, the protective medium may at the same time serve as a removal aid and therefore even contribute to the improvement of the cleaning process.

Experiments have shown that carbon dioxide dissolves well in the commonly used waxes at pressures of 300 bar and up, preferably 500 bar and up (see also FIG. 3). Conversely, commonly available waxes dissolve relatively poorly in carbon dioxide and do not attain relevant levels of solubility until pressures of approximately 700 bar. Here, temperature displays only a relatively small influence on the solubility and instead tends to influence dissolution speed more.

The increased solubility of the protective medium in carbon dioxide at pressures of 700 bar and up significantly improves its drainage ability and thereby also enables heavy metallic particles to be removed in the final process step according to the invention.

In a particularly advantageous embodiment of the method according to the invention, therefore, cleaning is accomplished by means of a further compression to a pressure in excess of 700 bar and heating to a temperature greater than 150° C. and a subsequent slow expansion. This final step improves the complete removal of easily vaporized protective media adhering to the surface and any additional metallic particles that may be present, for example, such as those that occur during laser boring.

The advantages that are attainable using the advantageous embodiment of the invention lie in particular in the fact that the method, under the conditions of supercritical CO₂ in a first range at a pressure in excess of 500 bar and a temperature above 150° C., displays good cleaning characteristics with regard to commercially available waxes and, in a second range at a pressure in excess of 700 bar and a temperature above 150° C., the solubility of wax in CO₂ increases to a surprisingly disproportionate degree. As a result, it is sufficient for the cleaning tank to be subjected cyclically to the conditions of the first range only a few times (1 to 3 times) for the wax to be dissolved completely and, subsequently, for it to be subjected once to the conditions of the second range so as to also remove any additional heavy metallic particles that may be present. Advantageously, the minimized effort of the method reduces the time of the cleaning process for, for example, a turbine blade, to 20 minutes or less, for example, in contrast to current cleaning times of up to two hours. Moreover, the method is appropriate for use in serial production, with corresponding cost advantages.

In a further development of the invention, the pressure tank is essentially completely filled before cleaning with one or more objects to be cleaned, as well as with a plurality of solid filler objects. In this case, the pressure tank must be filled with considerably less cleaning medium, thereby saving compression work.

The device according to the invention for applying a protective medium to a turbine blade, in particular to the inner surface of a hollow turbine blade includes:
a carbon dioxide supply, connected to
a compressor for compressing the carbon dioxide, connected to
a heat exchanger for tempering the carbon dioxide, connected to
a pressure tank for accommodating the turbine blade and the tempering and/or cleaning thereof, connected to
a precipitator for precipitating impurities in the carbon dioxide, connected to the carbon dioxide supply,
with the
tempering and/or cleaning tank additionally being connected to a storage tank for the protective medium to be applied.

In contrast to the device known from DE 10218519 C1, the device according to the invention for cleaning a turbine blade additionally has a storage tank for the protective medium to be applied that is connected to the pressure tank for accepting the turbine blade. In this manner, it is possible for the device according to the invention to be used for tempering the turbine blade, as well as for filling it with the protective medium, as well as for cleaning it after laser boring, resulting in a very high degree of efficacy.

The device is structured in a particularly advantageous fashion when the storage tank is connected to the precipitator. In this case, the protective medium that is washed out during cleaning of the bored turbine blade with the carbon dioxide may be separated from the carbon dioxide by the precipitator and conveyed back to the storage tank.

In a further advantageous embodiment, the tempering and/or cleaning tank is connected to the carbon dioxide supply by more than one loop. This allows the particularly efficient two-stage cleaning process to be conducted with flashing and extraction.

Other features and advantages of the invention may be found in the description of exemplary embodiments below and with reference to the figures.

### BRIEF DESCRIPTION OF THE DRAWINGS

FIG. 1 illustrates a schematic structure of the tempering and/or cleaning facility;

FIGS. 2a to 2e illustrate principal chronological sequences of the individual cleaning steps; and

FIG. 3 is a graph that illustrates the solubility of carbon dioxide in wax and vice versa.

### DETAILED DESCRIPTION OF THE DRAWINGS

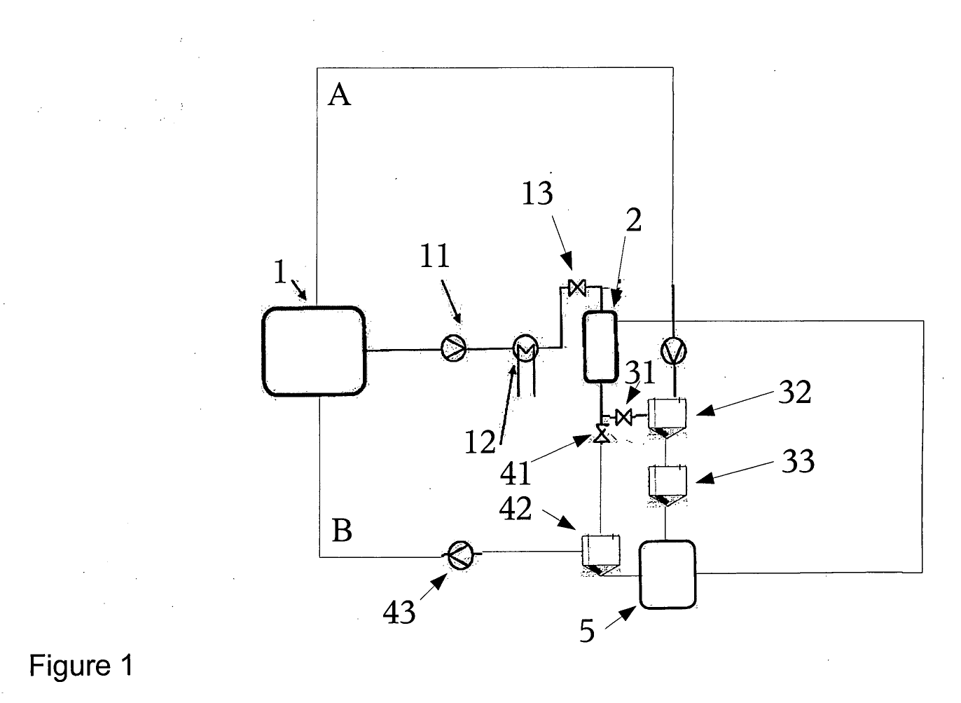

FIG. 1 shows a tempering and/or cleaning system schematically and not to scale. The system has a carbon dioxide supply 1, here a commercially available rented bottle. The carbon dioxide supply 1 contains carbon dioxide at a pressure of 80 bar. It is connected to the tempering and/or cleaning tank 2 by way of a high-pressure pump 11, a heat exchanger 12, and a throttle 13. The cleaning tank 2 is connected to an impurity precipitator 32 in a loop A by way of a throttle 31 and is then connected back to the carbon dioxide supply 1. Moreover, the cleaning tank 2 is connected to a wax precipitator 42 in a loop B by way of a throttle 41 and is then connected back to the carbon dioxide supply 1 by way of a compressor 43. The impurity precipitator 32 is connected to a wax precipitator 33. The wax precipitators 33 and 42 are connected to a wax supply 5, which is connected in-turn to the tempering and/or cleaning tank 2.

According to a first exemplary embodiment, the system described above serves only as a tempering system; cleaning after laser boring is conducted in a conventional fashion using a fluorocarbon bath.

In this first exemplary embodiment, the hollow turbine blade to be provided with cooling bores is placed in the tempering tank 2, which is then closed. In the tempering tank 2, the pressure and temperature are increased into the supercritical range for carbon dioxide (e.g., 200° C., 700 bar). Then, the carbon dioxide from the carbon dioxide supply 1 is compressed using the high-pressure pump 11 and heated by means of the heat exchanger 12 and admitted into the tempering tank 2 in a supercritical state. The hot, supercritical carbon dioxide fills all of the hollow spaces of the turbine blade and heats the entire turbine blade evenly from the inside and outside at the same time. Then the carbon dioxide is released from the tempering tank 2 by way of the loop B and returned to the supply 1 in a pressure-free manner. The tempering tank 2 is evacuated to a vacuum. Liquid wax is injected into the turbine blade from the wax supply 5 and fills its hollow spaces completely. The wax may be injected or poured in at 85° C. and 1.5 bar or at 120° C. to 130° C. and 0.8 to 1.2 bar. The tempering tank 2 is depressurized and cooled. Excess wax is precipitated in the wax precipitator and then returned to the wax supply 5. The filled turbine blade is removed.

According to a second exemplary embodiment, the system described above is used as a tempering system as well as a cleaning system.

In this second exemplary embodiment, the hollow turbine blade to be provided with cooling bores is placed in the tempering/cleaning tank 2, which is then closed. The application of a protective medium composed of wax to the inner surfaces of the turbine blade occurs according to the first exemplary embodiment. The required cooling bores are placed in the filled turbine blade by means of laser boring. Residual wax and any other impurities are cleaned from the turbine blade in the tempering/cleaning tank 2.

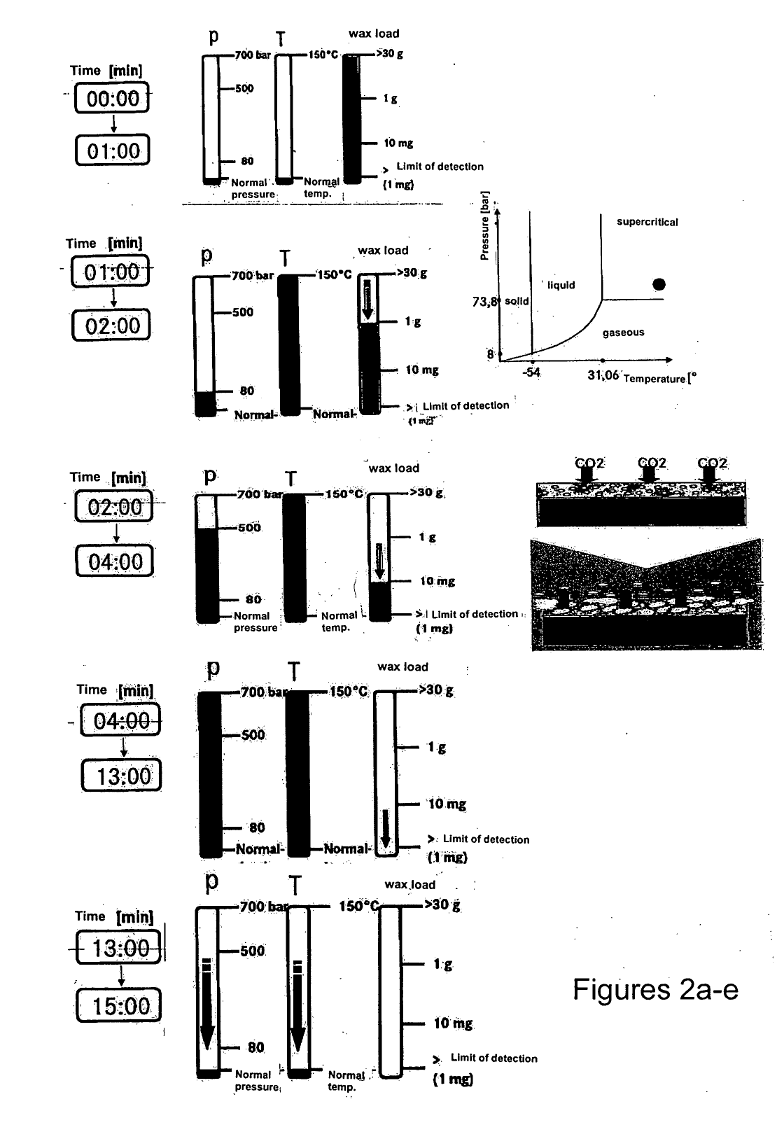

The principal chronological sequence of the cleaning process is shown in FIGS. 2a to 2e. In a first step lasting approximately one minute, the turbine blade to be cleaned is placed in the tempering/cleaning tank 2, which is closed at normal temperature and pressure. In a second step lasting approximately another minute, hot carbon dioxide flows through the tempering/cleaning tank 2 by way of the loop A at a pressure of approximately 80 bar and a temperature of approximately 150° C. Here, a large portion of the wax is melted out and flows away. During this process, the wax load of the turbine blade is reduced from over 30 g to approximately 1 g. The wax is precipitated in the wax precipitator 33 and conducted to the wax supply 5. In a third step lasting approximately two minutes, approximately 99 percent of the remaining wax is washed away by repeated spontaneous relaxing of the supercritical carbon dioxide (known as “flashing”). For this purpose, the tempering/cleaning tank 2 is filled with supercritical carbon dioxide at 700 bar and 200° C. and then spontaneously relaxed. In so doing, the supercritical carbon dioxide vaporizes suddenly and carries the remaining wax with it. The wax is precipitated in the wax precipitator 42 and conducted to the wax supply 5. The relaxed carbon dioxide is compressed again by means of the compressor 43 and returned to the carbon dioxide supply 1. In a fourth step, the remaining wax is dissolved in supercritical carbon dioxide. For this purpose, the tempering/cleaning tank 2 is filled with supercritical carbon dioxide at 700 bar and 200° C. Mter approximately 9 minutes, the remaining wax has completely dissolved in the supercritical carbon dioxide. In a fifth step lasting approximately 2 minutes, the tempering/cleaning tank 2 is slowly relaxed. Here, the dissolved wax is removed along with the supercritical carbon dioxide and precipitated in the wax precipitator and then returned to the wax supply 5. The relaxed carbon dioxide is compressed again by means of the compressor 43 and returned to the carbon dioxide supply 1.

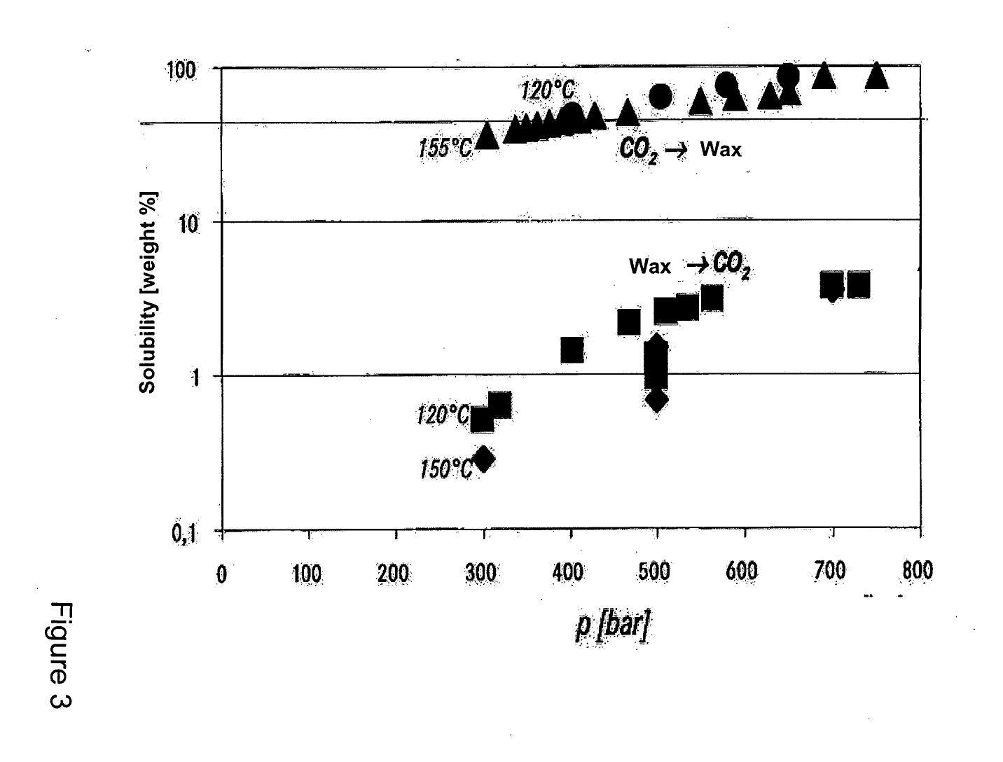

FIG. 3 shows the solubility of carbon dioxide in wax and vice versa. It becomes clear that supercritical carbon dioxide is easily soluble in wax and this solubility improves as pressure increases. Conversely, wax is sparingly soluble in supercritical carbon dioxide below 300 bar (<<1 wt.-%) and does not achieve a relevant solubility of a few percent by weight until approximately 700 bar. However, this is sufficient to allow turbine blades to be cleaned in a residue-free manner. This figure also shows that the temperature has a relatively low influence on solubility; temperature essentially influences kinetics, i.e., dissolving speed.

### LIST OF REFERENCE NUMBERS

1 Carbon dioxide supply
11 High-pressure pump, compressor
12 Heat exchanger
13 Throttle
2 Tempering and/or cleaning tank
31 Throttle
32 Impurity precipitator
33 Wax precipitator
41 Throttle
42 Wax precipitator
43 High-pressure pump, compressor
5 Wax supply

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for cleaning a turbine blade that has been coated with a protective medium, with cleaning being performed by means of supercritical CO₂ in a pressure tank and the CO₂ being successively compressed and decompressed one or more times and, for this purpose, being compressed to a pressure in excess of 500 bar and heated to a temperature above 150° C., and subsequently being cooled and decompressed such that the gas assumes a volume that is a multiple of a volume of the compressed CO₂ in the pressure tank.

2. A method for the application of a protective medium to a hollow turbine blade, comprising the steps of:
insertion of the turbine blade into a pressure tank;
increasing a pressure and a temperature of the pressure tank to a supercritical range of CO₂;
admitting hot, supercritical CO₂ into the pressure tank;
heating the turbine blade by the hot, supercritical CO₂;
removing the CO₂ from the pressure tank;
lowering the pressure under a normal pressure in the pressure tank;
introducing a liquid protective medium into the hollow turbine blade;
adjusting environmental conditions in the pressure tank; and
removing the turbine blade from the pressure tank.

3. A method for placing cooling bores in a turbine blade, comprising the steps of:
application of a protective medium according to claim 2;
placing the cooling bores using laser beams; and
cleaning the turbine blade using supercritical CO₂.

4. The method for placing cooling bores in a turbine blade according to claim 3, with the cleaning being performed using supercritical CO₂ in the pressure tank and with the CO₂ being successively compressed and decompressed one or more times and, for this purpose, being compressed to a pressure in excess of 500 bar and heated to a temperature above 150° C., and subsequently being cooled and decompressed such that the gas assumes a volume that is a multiple of a volume of the compressed CO₂ in the pressure tank.

5. The method according to claim 4, wherein the CO₂ is finally compressed to a pressure in excess of 700 bar and heated to a temperature above 150° C., and is subsequently decompressed and cooled.

6. A device for the application of a protective medium to a hollow turbine blade, comprising:
a carbon dioxide supply;
a compressor for compressing carbon dioxide coupled to the carbon dioxide supply;
a heat exchanger for tempering the carbon dioxide coupled to the compressor;
a pressure tank for accommodating the turbine blade and for tempering and/or cleaning thereof coupled to the heat exchanger;
a precipitator for precipitating impurities in the carbon dioxide coupled to the pressure tank and the carbon dioxide supply; and
a protective medium storage tank coupled to the pressure tank.

7. The device according to claim 6, wherein the protective medium storage tank is connected to the precipitator.

8. The device according to claim 6, wherein the pressure tank is connected to the carbon dioxide supply by way of more than one loop.

9. A method for cleaning a turbine blade that has been coated with a protective medium, comprising the steps of:
cleaning the turbine blade in a pressure tank with supercritical CO₂ by compressing the CO₂ to a pressure in excess of 500 bar and heating the CO₂ to a temperature above 150° C., and subsequently cooling and decompressing the CO₂ such that the CO₂ expands and assumes a volume that is a multiple of a volume of the compressed CO₂ in the pressure tank.

10. The method according to claim 9, wherein the protective medium is a wax.

11. The method according to claim 10, further comprising the step of dissolving the wax in the compressed CO₂.

12. The method according to claim 11, further comprising the step of precipitating the wax from the CO₂.

13. The method according to claim 12, further comprising the step of supplying the precipitated wax to a wax supply.

14. The method according to claim 12, further comprising the step of supplying the CO₂ to a carbon dioxide supply.

15. The method according to claim 2, wherein the step of heating the turbine blade by the hot, supercritical CO₂ includes the step of filling hollow spaces of the turbine blade with the CO₂.

16. The method according to claim 2, wherein the protective medium is a wax.
